(19) United States
(12) Patent Application Publication
(10) Pub. No.: US 2002/0172791 A1
(43) Pub. Date: Nov. 21, 2002

(54) Self-adhesive material

(76) Inventor: Roy T. Smith, King's Lynn (GB)

Correspondence Address: SUE Z. SHAPER, P.C., 2925 BRIARPARK, SUITE 930, HOUSTON, TX, 77042, US

(21) Appl. No.: 10/135,110

(22) Filed: Apr. 30, 2002

(30) Foreign Application Priority Data
May 15, 2001 (GB) 0111818.1

(51) Int. Cl. B32B 9/00

(52) U.S. Cl. 428/40.1

(57) ABSTRACT

A self adhesive layered material having a body and a porous felt-like material with a coating on the front side consisting of a first peelable adhesive and on the rear side of the body, a permanent bonding adhesive to which is applied a plastics intermediate film, the rear of which is coated with a second peelable adhesive. Release material may be laid on to the peelable adhesive layers.

### CROSS REFERENCE TO RELATED APPLICATIONS

This application is related to, and claims priority based on, Great Britain Application Serial No. GB 0111818.1 filed May 15, 2001 entitled Self Adhesive Material.

### FIELD OF THE INVENTION

The present invention relates to a self-adhesive material which includes a peelable adhesive enabling sheets of paper to be stuck to the material impermanently.

### BACKGROUND OF THE INVENTION

A self adhesive material, which includes a peelable adhesive enabling sheets of paper to be stuck to the material impermanently, is known and is used to display notes in, for instance, a domestic situation like a kitchen. The known material, sold by Gripping Stuff International Ltd of Walton-on-Thames, Surrey, England, comprises a synthetic felt-like material which is impregnated with a peelable adhesive and is sold with release material on each side of the felt-like material. The release material is peeled off one side and then that side is stuck to a base, for instance the inside of a door of a kitchen cabinet. The release material on the other side of the felt is then peeled off to provide in effect a “pinless” notice board.

A problem with the known material is that it is very difficult to design a suitable adhesive which on one side sticks adequately and effectively to the base which requires semi permanent adhesion yet on the other side requires temporary adhesion for say paper notes. Clearly, such an adhesive impregnated material due to the wide range of requirements requires an adhesive having a performance tolerance which is critical, and therefore the control over the coating of the material with adhesive on the back must be tight. The use of felt and synthetic felts as the body for the self adhesive material, because it is porous, makes control very difficult yet it is important to have a felt-like material both for appearance and for padding against unevenness.

### SUMMARY OF THE INVENTION

According to the instant invention, there is provided a self adhesive material having a body of porous felt-like material coated on its front side with a first peelable adhesive and on its rear side with a permanent bonding adhesive, the bonding adhesive having applied thereto a plastics intermediate film, the rear of which is coated with a second peelable adhesive.

The resulting material can be “tailored” for different purposes or for application to different backing surfaces by making, for example, the second peelable adhesive much stronger than the first. Furthermore, an intermediate film, which is preferably impervious, stops the second peelable adhesive from tending to migrate more to the front. The intermediate film also enables better control in applying the second peelable adhesive.

The felt-like material is preferably about 1 mm thick synthetic material formed from polyester viscose, polypropylene or acrylic plastics. The intermediate film may also be found from a similar range. The peelable adhesives may be formed from water based acrylics.

The self adhesive material of the invention would normally be sold with a protective membrane on each side which may be formed from a siliconised plastic film or paper.

### BRIEF DESCRIPTION OF THE DRAWINGS

A better understanding of the present invention can be obtained when the following detailed description of the preferred embodiments are considered in conjunction with the following drawings, in which:

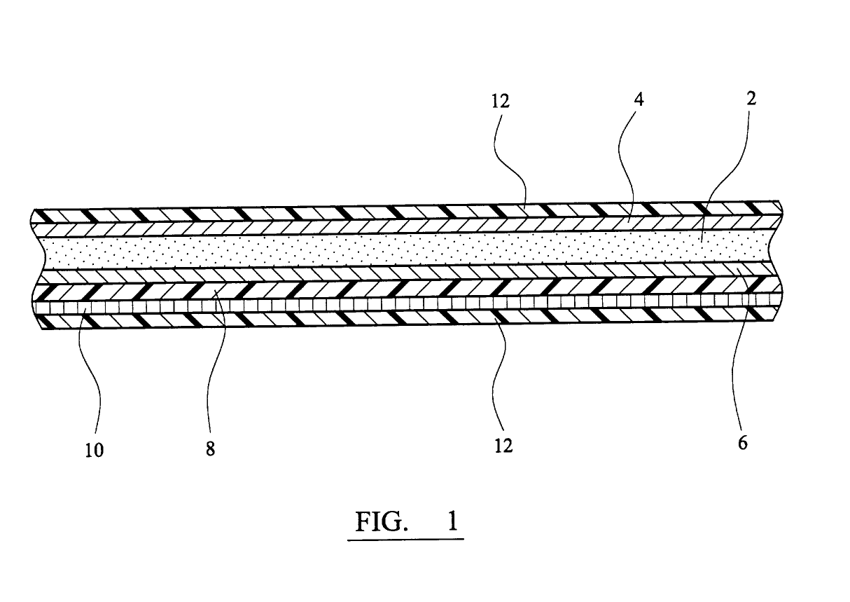

An embodiment of the invention will now be described by way of example with reference to the accompanying drawing which shows in FIG. 1 a diagrammatic cross section of the material of the invention.

### DESCRIPTION OF PREFERRED EMBODIMENTS

The self adhesive material according to the illustrated embodiment is formed from a body 2 of a porous synthetic felt-like material about 1 mm thick. Its intended front side is coated with a first peelable adhesive 4, preferably a water based acrylic which being non-oily does not damage notes or notices stuck temporarily to it. On the intended rear side is a coating 6 of a bonding adhesive designed to permanently attach the felt body 2 to an impervious intermediate plastics film 8. Film 8 is in turn coated with any desirable second peelable adhesive 10, the adhesive strength of which is normally greater than that of the first peelable adhesive 4.

The second peelable adhesive can indeed be so strong that it is virtually a bonding adhesive though the adhesive strength of bonding adhesive 6 should be greater than that of adhesive 10.

Both sides of the complete material 2-10 should be covered with release material 12 which may be made of paper or plastics.

The felt is normally coloured and this will show through the release material if it is reasonably clear.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below.

What is claimed is:

1. A self adhesive material having a body of porous felt-like material coated on its front side
with a first peelable adhesive and on its rear side with a permanent bonding adhesive, the bonding adhesive having applied thereto a plastics intermediate film, the rear of which is coated with a second peelable adhesive.

2. A material as claimed in claim 1 wherein the intermediate film is impervious to adhesive.

3. A material as claimed in claim 1 or 2 wherein the first peelable adhesive is formed from a water based acrylic.

4. A material as claimed in claim 1 or 2 wherein the felt-like material is between ½ and 2 mm and substantially 1 mm thick.

5. A material as claimed in claim 3 wherein the felt-like material is between ½ and 2 mm and substantially 1 mm thick.

6. A material as claimed in claim 1 or 2 which is protected on both sides by a release film of paper or plastics material.

7. A material as claimed in claim 3 which is protected on both sides by a release film of paper or plastics material.

8. A material as claimed in claim 4 which is protected on both sides by a release film of paper or plastics material.

9. A self adhesive material having a body of porous felt-like material coated on its front side with a first peelable adhesive and on its rear side with a permanent bonding adhesive, the bonding adhesive having applied thereto a plastics intermediate film, the rear of which is coated with a second peelable adhesive, the intermediate film being impervious to adhesive.

10. A self adhesive material having a body of porous felt-like material coated on its front side with a first peelable adhesive and on its rear side with a permanent bonding adhesive, the bonding adhesive having applied thereto a plastics intermediate film, the rear of which is coated with a second peelable adhesive, the intermediate film being impervious to adhesive wherein the first peelable adhesive being formed from a water based acrylic.

11. A self adhesive material having a body of porous felt-like material coated on its front side with a first peelable adhesive and on its rear side with a permanent bonding adhesive, the bonding adhesive having applied thereto a plastics intermediate film, the rear of which is coated with a second peelable adhesive, the intermediate film being impervious to adhesive, the first peelable adhesive being formed from a water based acrylic, wherein the felt-like material is between ½ and 2 mm and substantially 1 mm thick.

12. A self adhesive material having a body of porous felt-like material coated on its front side with a first peelable adhesive and on its rear side with a permanent bonding adhesive, the bonding adhesive having applied thereto a plastics intermediate film, the rear of which is coated with a second peelable adhesive, the intermediate film being impervious to adhesive, the first peelable adhesive being formed from a water based acrylic, the felt-like material being between ½ and 2 mm and preferably substantially 1 mm thick, wherein the material is protected on both sides by a release film of paper or plastics material.

13. A notice adherent laminate, comprising a body of porous material coated on its front side with a first peelable adhesive and on its rear side with a permanent bonding adhesive, the bonding adhesive having applied thereto a plastics intermediate film, the rear of which is coated with a second peelable adhesive.

14. A laminate as claimed in claim 13 wherein the intermediate film is impervious to adhesive.

15. A self-adhesive laminate having a body of felt-like material on the front side of which is a first peelable adhesive and on the rear side of which is a permanent bonding adhesive, the rear side having next to the bonding adhesive a plastics intermediate film and next to the intermediate film on its rear, a second peelable adhesive, the laminate enabling sheets of paper to be stuck impermanently on its front side.

16. A laminate as claimed in claim 15 wherein the intermediate film is impervious to adhesive.
